(19) United States
(12) Patent Application Publication
(10) Pub. No.: US 2016/0076292 A1
(43) Pub. Date: Mar. 17, 2016

(54) HINGE

(71) Applicant: Michael Christopher STUART, (US)

(72) Inventor: Michael Christopher Stuart, Five Dock (AU)

(21) Appl. No.: 14/784,233

(22) PCT Filed: Apr. 15, 2014
(86) PCT No.: PCT/AU2014/000431

§ 371 Date: Oct. 13, 2015

(30) Foreign Application Priority Data
Apr. 15, 2013 (AU) 2013901308

(51) Int. Cl. E05F 3/20; E05D 11/08; E05F 5/02; F16B 1/00

(52) U.S. Cl. CPC E05F 3/20; F16B 1/00; E05D 11/082; E05F 5/02; F16B 2001/0035

(57) ABSTRACT

Disclosed is a hinge including: a first hinge member including a first magnetic element; a second hinge member including a second magnetic element pivotally mounted to the first hinge member: a braking mechanism configured to hinder hinged motion of the hinge members; and a biasing mechanism to bias the first hinge member and the second hinge member toward a retained position. The first and second hinge members are substantially maintained in the retained position via magnetic force between the first and second magnetic elements. In certain embodiments, the first hinge member includes an angled overlapping portion and the second hinge member includes a dampening mechanism to slow hinged movement of the first hinge member relative to the second hinge member. The dampening mechanism is orientated substantially orthogonal to the angled overlapping portion which urges against the dampener when approaching the retained position.

### CROSS-REFERENCE TO RELATED APPLICATIONS

The present application claims priority from Australian Provisional Patent Application No 2013901308 filed on 15 Apr. 2013, the content of which is incorporated herein by reference.

### TECHNICAL FIELD

The present invention relates to a hinge.

### BACKGROUND ART

WO 2009/018615 describes a hinge including a mechanical biasing element and a plurality of magnetic elements which bias and retain hinge members in a retained position. The hinge included a dampener that extended orthogonal to the plane of the hinge members, wherein the dampener slowed hinged movement of the hinge members when approaching the retained position. The speed which hinge members approached the retained position could not be controlled nor adjusted. Additionally, the dampener extended orthogonal to the plane of the hinge members thereby causing the hinge members to be rather bulky in thickness in order to adequately house the body of the dampener.

Therefore there exist a need for an improved hinge that overcomes or at least ameliorates one or more of the above disadvantages of the prior art.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

### SUMMARY

In a first aspect there is provided a hinge including:

a first hinge member including a first magnetic element;

a second hinge member including a second magnetic element, wherein the first and second hinge members are pivotally mounted together;

a braking mechanism configured to hinder movement of the first hinge member relative to the second hinge member during at least a portion of hinged motion; and

a biasing mechanism configured to bias the first hinge member and the second hinge member toward the retained position;

wherein the first and second hinge members are substantially maintained in a retained position via magnetic force between the first and second magnetic elements.

In certain embodiments, a braking force created by the braking mechanism is adjustable.

In certain embodiments, the braking mechanism includes a threaded element mounted in the first hinge member, the threaded element being in contact with the second hinge member and hindering relative motion by friction.

In certain embodiments, the first hinge member includes a removable cover for covering the threaded element.

In certain embodiments, the second hinge member includes a recessed section such that the braking force applied by the braking mechanism varies through the hinged motion.

In certain embodiments, the second hinge member includes a tongue which is pivotally secured to the first hinge member, wherein a surface of the tongue includes the recessed section.

In certain embodiments, the tongue includes a rounded end section, wherein the recessed section is provided in the rounded end section of the tongue.

In certain embodiments, the rounded end of the tongue includes a hollow, wherein the tongue is pivotally secured to the first hinge member via a hinge pin mechanism which is at least partially housed within the hollow and is secured to the first hinge member.

In certain embodiments, the hinge pin mechanism includes:

a first end portion including a first shoulder section having a void;

a second end portion including a second shoulder section having extending therefrom a rod; and

a spring which is coaxially located upon the rod, wherein a portion of the rod is secured within the void thereby securing the spring to the first and second end portions.

In certain embodiments, a first spring tail of the spring extends outwardly from the rod and a second spring tail is secured to the second shoulder section.

In certain embodiments, the tongue includes a cut-out section which receives therein the first spring tail.

In certain embodiments, the first hinge member includes an angled overlapping portion which urges against a portion of an angled dampening mechanism protruding from second hinge member, wherein the dampening mechanism has an axis which is substantially orthogonal to the angled overlapping portion, wherein the dampening mechanism is configured to slow the hinged movement of the first hinge member relative to the second hinge member.

In certain embodiments, the overlapping portion of the first hinge member is a chamfer and the second hinge member includes an underlapping portion providing a complementary chamfer, wherein the overlapping portion rests against the underlapping portion when the hinge is in the retained position.

In certain embodiments, a face of the overlapping portion includes a striker plate which strikes a pin protruding from the dampening mechanism as the hinge approaches the retained position.

In certain embodiments, the underlapping section includes a plurality of angled apertures for enabling a body of the dampening mechanism to protrude through a front hinge plate of the second hinge member.

In certain embodiments, an end portion of the dampening mechanism rests in an angled recess in a rear hinge plate of the second hinge member.

In certain embodiments, the hinge includes a plurality of dampening mechanisms to slow the hinged movement of the hinge toward the retained position.

In certain embodiments, the second hinge member includes a mounting portion including holes for mounting the hinge to a mounting surface.

In certain embodiments, the mounting portion is a mounting block.

In certain embodiments, the first hinge member includes a first front plate and a first rear plate which secure a hinged item therebetween, and the second hinge member includes a second rear plate, wherein the first front plates extends a length of the hinge.

In another aspect there is provided a hinge including:

a first hinge member including:
a first magnetic element; and
an angled overlapping portion;

a second hinge member, pivotally mounted to the first hinge member, including:
a second magnetic element, wherein the first and second hinge members are substantially maintained in a retained position via magnetic force between the first and second magnetic elements; and
a dampening mechanism configured to slow the movement of the first hinge member relative to the second hinge member, wherein the dampening mechanism is orientated substantially orthogonal to the angled overlapping portion which urges against the dampener when approaching the retained position; and

a biasing mechanism configured to bias the first hinge member and the second hinge member toward the retained position.

In certain embodiments, the overlapping portion of the first hinge member is a chamfer and the second hinge member includes an underlapping portion providing a complementary chamfer, wherein the overlapping portion rests against the underlapping portion when the hinge is in the retained position.

In certain embodiments, a face of the overlapping portion includes a striker plate which strikes a pin protruding from the dampening mechanism as the hinge approaches the retained position.

In certain embodiments, the underlapping section includes a plurality of angled apertures for enabling a body of the dampening mechanism to protrude through a front hinge plate of the second hinge member.

In certain embodiments, an end portion of the dampening mechanism rests in an angled recess in a rear hinge plate of the second hinge member.

In certain embodiments, the hinge includes a plurality of dampening mechanisms to slow the hinged movement of the hinge toward the retained position.

In certain embodiments, the hinge includes a braking mechanism configured to hinder movement of the first hinge member relative to the second hinge member during at least a portion of hinged motion.

In certain embodiments, a braking force created by the braking mechanism is adjustable.

In certain embodiments, the braking mechanism includes a threaded element mounted in the first hinge member, the threaded element being in contact with the second hinge member and hindering relative motion by friction.

In certain embodiments, the first hinge member includes a removable cover for covering the threaded element.

In certain embodiments, the second hinge member includes a recessed section such that the braking force applied by the braking mechanism varies through the hinged motion.

In certain embodiments, the second hinge member includes a tongue which is pivotally secured to the first hinge member, wherein a surface of the tongue includes the recessed section.

In certain embodiments, the tongue includes a rounded end section, wherein the recessed section is provided in the rounded end section of the tongue.

In certain embodiments, the rounded end of the tongue includes a hollow, wherein the tongue is pivotally secured to the first hinge member via a hinge pin mechanism which is at least partially housed within the hollow and is secured to the first hinge member.

In certain embodiments, the hinge pin mechanism includes:

a first end portion including a first shoulder section having a void;

a second end portion including a second shoulder section having extending therefrom a rod; and

a spring which is coaxially located upon the rod, wherein a portion of the rod is secured within the void thereby securing the spring to the first and second end portions.

In certain embodiments, a first spring tail of the spring extends outwardly from the rod and a second spring tail is secured to the second shoulder section.

In certain embodiments, the tongue includes a cut-out section which receives therein the first spring tail.

In certain embodiments, the second hinge member includes a mounting portion including holes for mounting the hinge to a mounting surface.

In certain embodiments, the mounting portion is a mounting block.

In certain embodiments, the first hinge member includes a first front plate and a first rear plate which secure a hinged item therebetween, and the second hinge member includes a second rear plate, wherein the first front plates extends a length of the hinge.

In a further aspect there is provided a kit of parts for a hinge including:

a first hinge member including a first magnetic element;

a second hinge member including a second magnetic element, wherein the first and second hinge members are to be pivotally mounted together;

a braking mechanism configured to hinder movement of the first hinge member relative to the second hinge member during at least a portion of hinged motion; and

a biasing mechanism configured to bias the first hinge member and the second hinge member toward the retained position;
wherein the first and second hinge members are substantially maintained in a retained position via magnetic force between the first and second magnetic elements.

In a further aspect there is provided a kit of parts for a hinge including:

a first hinge member including:
a first magnetic element; and
an angled overlapping portion;

a second hinge member, to be pivotally mounted to the first hinge member, including:
a second magnetic element, wherein the first and second hinge members are substantially maintained in a retained position via magnetic force between the first and second magnetic elements; and
a dampening mechanism configured to slow the movement of the first hinge member relative to the second hinge member, wherein the dampening mechanism is orientated substantially orthogonal to the angled overlapping portion which urges against the dampener when approaching the retained position; and

a biasing mechanism configured to bias the first hinge member and the second hinge member toward the retained position.

Other aspects and embodiment will be realised throughout the detailed description.

### BRIEF DESCRIPTION OF FIGURES

The example embodiment of the present invention should become apparent from the following description, which is given by way of example only, of a preferred but non-limiting embodiment, described in connection with the accompanying figures.

FIG. 1 illustrates an isometric elevated view of an example of a hinge in a closed position;

FIG. 2 is a rear view of the hinge of FIG. 1 in the closed position;

FIG. 3 is a side view of the hinge of FIG. 1 in the closed position;

FIG. 4 is a top view of the hinge of FIG. 1 in the closed position;

FIG. 5 is an end view of the hinge of FIG. 1 in the closed position;

FIG. 6 is a cross-sectional view through section A-A of the hinge of FIG. 2;

FIG. 7 is an elevated isometric view of the hinge of FIG. 1 with the front hinge plates removed;

FIG. 8 is an elevated isometric view of a hinge pin mechanism of the hinge of FIG. 1;

FIG. 9 is an elevated exploded isometric view of a hinge pin mechanism of FIG. 6;

FIG. 10 is a cross-sectional view along the longitudinal axis of the hinge pin mechanism;

FIG. 11 is an elevated isometric view of the first rear plate of the hinge of FIG. 1;

FIG. 12 is an elevated isometric view of the second rear plate of the hinge of FIG. 1;

FIG. 13 is an end view of the second rear plate of FIG. 12;

FIG. 14 is a magnified view of area C showing the recessed section of the tongue of the second rear plate;

FIG. 15 is an elevated isometric view of the first front plate of the hinge of FIG. 1;

FIG. 16 is a cross-sectional view of front plate along section D-D of FIG. 15;

FIG. 17 is an elevated isometric view of the second front plate of the hinge of FIG. 1;

FIG. 18 is an elevated isometric view of the second magnetic element;

FIG. 19 is an elevated isometric view of the first magnetic element;

FIG. 20 is an elevated view of the dampener;

FIG. 21 is an isometric view of the hinge coupled to a first structure and a second structure;

FIG. 22 is an isometric view of the hinge in the closed position with the first front plate removed;

FIG. 23 is an isometric view of the hinge in the open position with the first front plate removed

FIG. 24 is front isometric view of another example of the hinge in the closed position;

FIG. 25 is a rear isometric view of the hinge of FIG. 24 in the closed position;

FIG. 26 is a end view of the hinge of FIG. 24 in the closed position;

FIG. 27 is a front isometric view of the hinge of FIG. 24 including a mounting plate;

FIG. 28 is a perspective view of the inner surface of the first and second rear plates of the hinge of FIG. 24;

FIG. 29 is a perspective view of the inner surface of the front plate of the hinge of FIG. 24; and

FIG. 30 is a perspective end view of the hinge manually held in the open position;

### MODES FOR CARRYING OUT THE INVENTION

The following modes, given by way of example only, are described in order to provide a more precise understanding of the subject matter of a preferred embodiment or embodiments.

In the figures, incorporated to illustrate features of an example embodiment, like reference numerals are used to identify like parts throughout the figures.

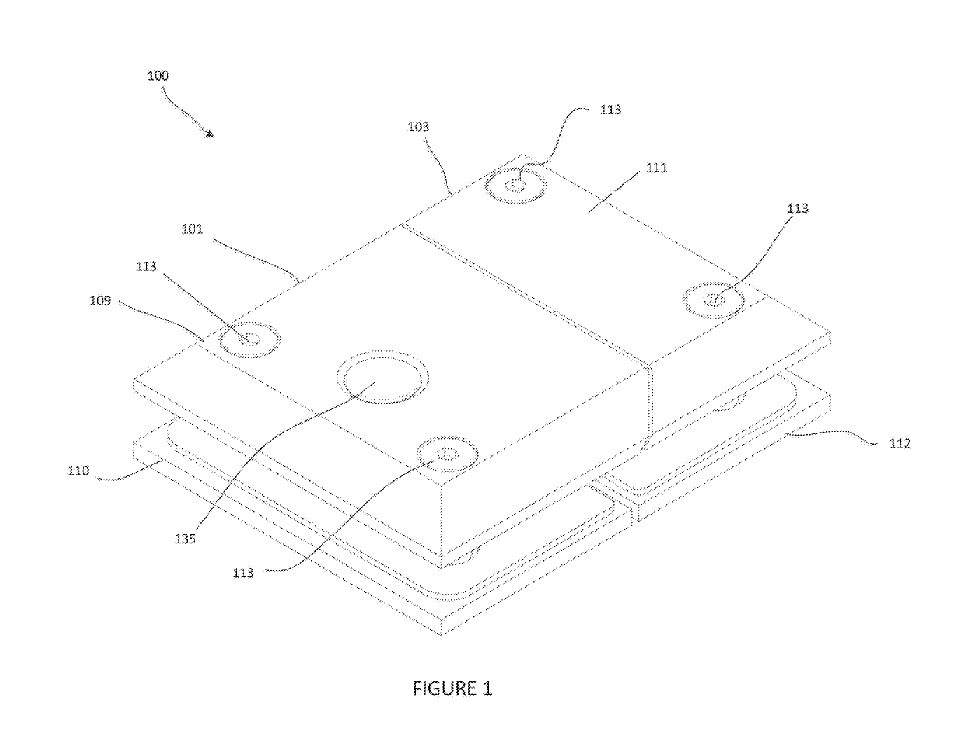

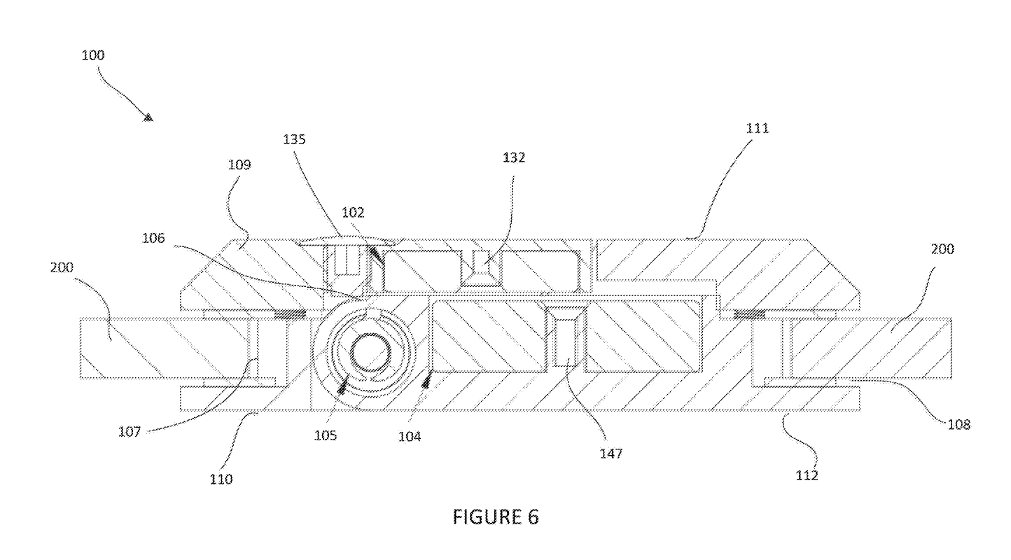

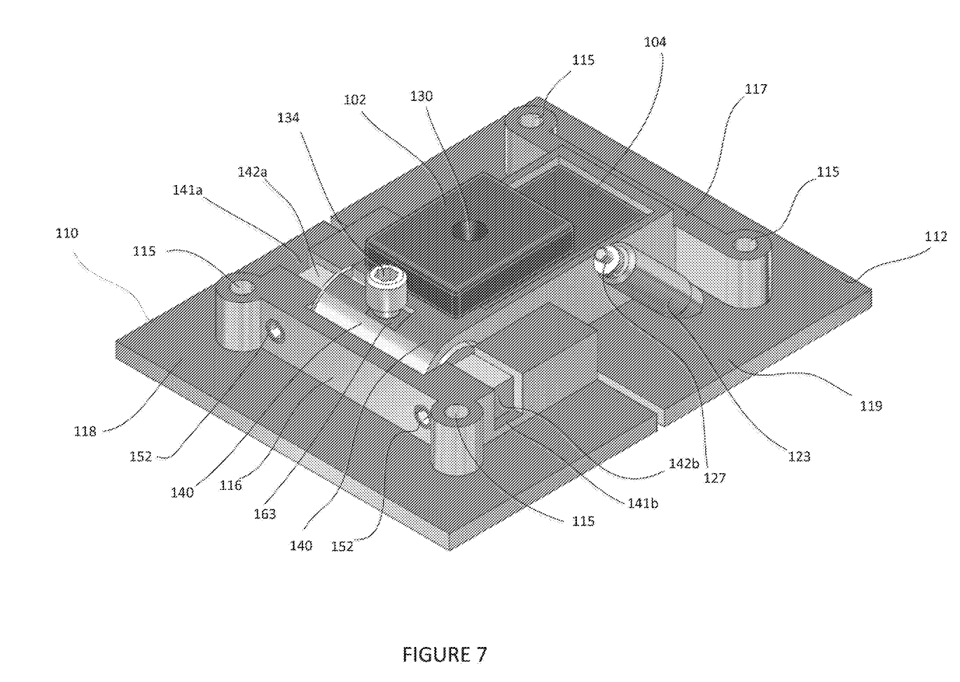

Referring to FIGS. 1 and 7 there is shown a hinge 100 including a first hinge member 101 including a first magnetic element 102 and a second hinge member 103 including a second magnetic element 104. The first and second hinge members 101, 103 are hingedly mounted together. The first and second hinged members 101, 103 are substantially maintained in a retained position (i.e. closed position) via attractive magnetic force between the first and second magnetic elements 102, 104. Referring to FIG. 6, the hinge 100 also includes a biasing mechanism 105 to bias the first and second hinge members 101, 103 from an unretained position to a retained position. Still referring to FIG. 6, the hinge 100 also includes a braking mechanism 106 configured to hinder the movement of the first hinge member 101 and the second hinge member 103 toward the retained position.

As shown in FIG. 7, when the first and second hinge members 101, 103 are maintained in the retained position, the first and second magnetic elements 102, 104 are superposed and aligned such that the close proximity between the first and second magnetic elements facilitate the retention of the first and second hinge members 101, 103 in the retained position. As shown in FIG. 7, the first magnetic element 102 contacts the second magnetic element 104 in the retained position.

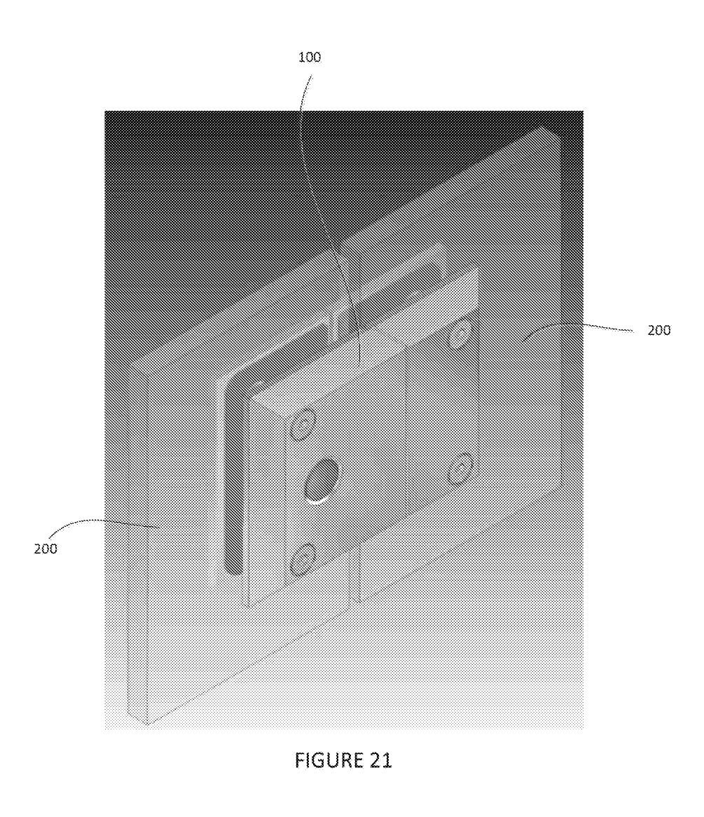

Referring to FIGS. 6 and 21, each hinge member 101, 102 includes a cavity 107, 108 that allows for door members 200 to be received and retained therein. In this particular instance, the hinge 100 is designed to couple to a frameless glass door for a shower. It will be appreciated that the hinge 100 may be used for other hinged items.

It will be appreciated that although the above described hinge 100 is configured to retain the hinge members 101, 103 in a retained position where the hinge members 101, 103 are parallel to each other as illustrated in FIG. 1, other arrangements are possible which result in the hinge 100 being maintained is other desired retained positions.

The magnetic elements 102, 104 are preferably of small size but are of significant magnetic strength and may be formed of alnico, neodymium (a rare earth metal) or like materials of high magnetic flux. Preferably the magnetic elements 102, 104 have sufficient magnetic strength that, in the absence of an intentional effort to move the door members 200 coupled to the hinge members 101, 103, the hinge members 101, 103 are maintained in the retained position. That is, the magnetic elements 101, 103 are sufficiently strong to preclude movement of hinge members 101, 103 from the retained position to the unstable or free moving position.

Referring to FIG. 5, the first hinge member 101 includes a first front plate 109 and a first rear plate 110. The second hinge member 103 includes a second front plate 111 and a second rear plate 112. The front and rear plates 109, 110, 111, 112 of the first and second hinge members 101, 103 are separable via releasable screws 113. In particular, the front plates 109, 111 include holes 114 which the screws 113 can be received therethrough. An end portion of each stem of the screws 113 engage with threaded holes 115 of a wall structure 116, 117 (see FIG. 7) provided on the internal faces 118, 119 of the first and second rear plates 110, 112.

As shown in FIG. 5, the first hinge member 101 includes an angled overlapping portion 120 that extends from the first front plate 109 and overlaps a corresponding underlapping angled portion 121 of the second front plate 111 in the retained position. The overlapping and underlapping angled portions 120, 121 are preferably angled at 45 degrees.

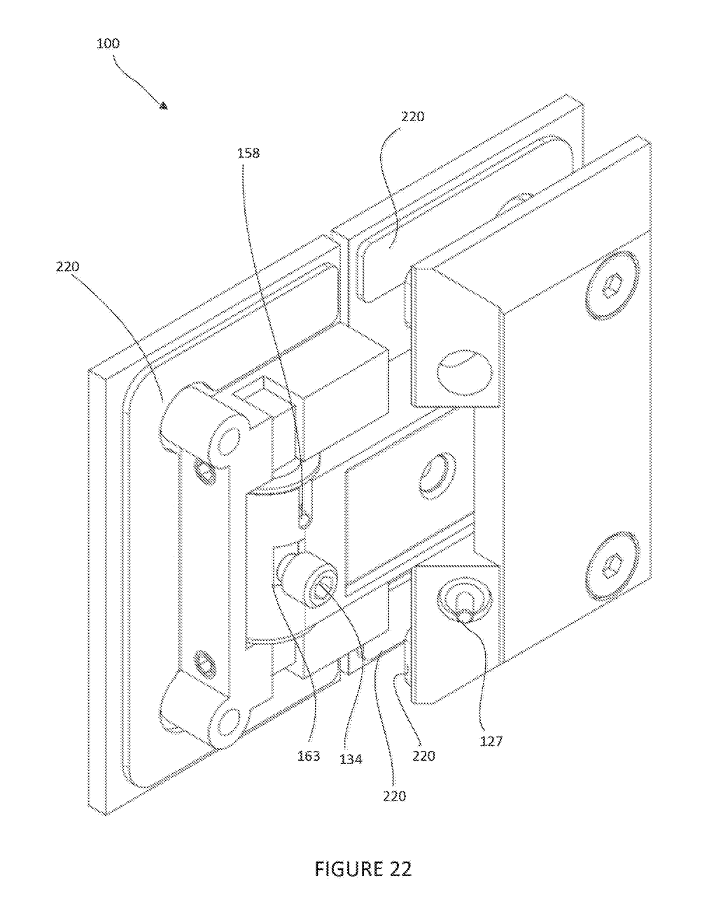

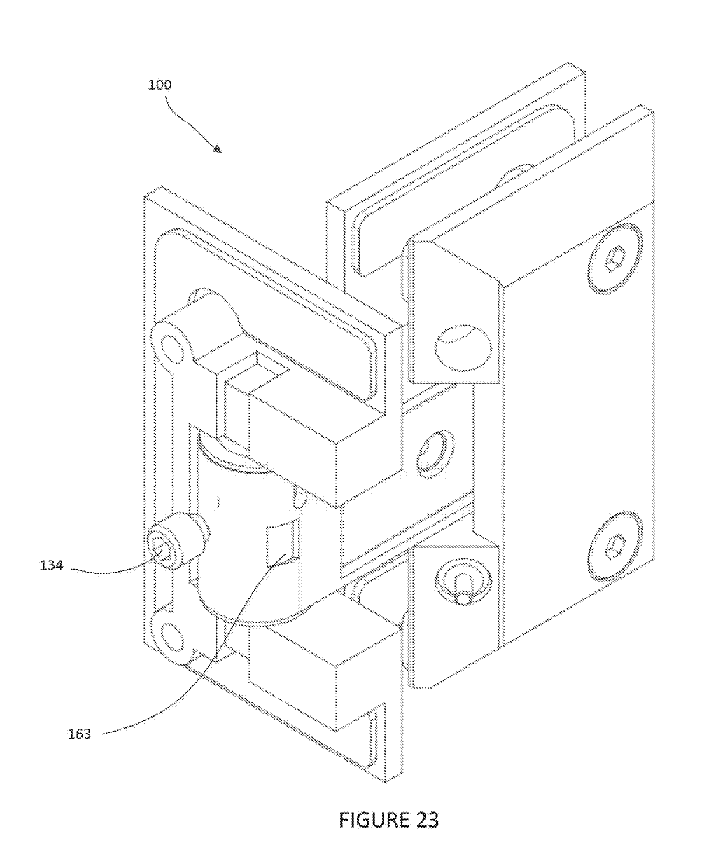

Referring to FIG. 17, the angled underlapping portion 121 of the second front plate 111 has a pair of angled apertures 122, wherein the axis of the apertures 122 is orthogonal to the angle of the angled underlapping portion 121. A dampener 123 can be provided in at least one aperture 122 (see FIGS. 22 and 23), wherein a base portion 124 of the dampener 123 rests within a recess 125 in the second rear plate (see FIGS. 5, 7 and 12). A body 126 of each dampener 123 may include a screw thread that engages with a internal screw thread of the respective angled aperture 122. As will be appreciated, the longitudinal axis of the dampener 123 is also orthogonal to the angle of the underlapping portion 121.

Due to the angled orientation of the dampeners 123, the thickness of the first and second hinge members 101, 103 is reduced compared to that of WO 2009/018615. This angled dampener configuration provides significant packaging advantages. As shown in FIGS. 22 and 23, the hinge 100 can include a single dampener 123 which protrudes from one of the angled protrusions 122. However, in instances where more dampening is required, a second dampener 123 can be provided in the other angled hole.

Each dampener 123 can be provided as a hydraulic mechanism, wherein a hydraulic pin 127 protrudes outwardly from the angled apertures 122 of the second front plate 111 of the second hinge member 103. When the hinge moves from an unstable position to the closed retained position, the underside angled surface of the overlapping portion 120 of the first front plate 109 of the first hinge member 101 urges against the end of the hydraulic pin 127, causing at least a portion of the pin 127 to gradually retract within a hydraulic cylinder, thereby slowing the movement of the hinge members 101, 103 to the retained closed position.

When the first and second hinge members 101, 103 are moved to the unretained position, as shown in FIG. 23, such that the underside surface of the overlapping angled portion 120 of the first hinge member 101 is no longer in contact with the hydraulic pin 127, at least a portion of the hydraulic pin 127 extends from the hydraulic cylinder 126 thereby resetting the dampener 123. The hydraulic mechanism may include a biasing arrangement within the hydraulic cylinder 126, such as a spring or the like, which urges the pin 127 to extend outwardly from the hydraulic cylinder more rapidly than the retraction of the pin 127 within the hydraulic cylinder 126.

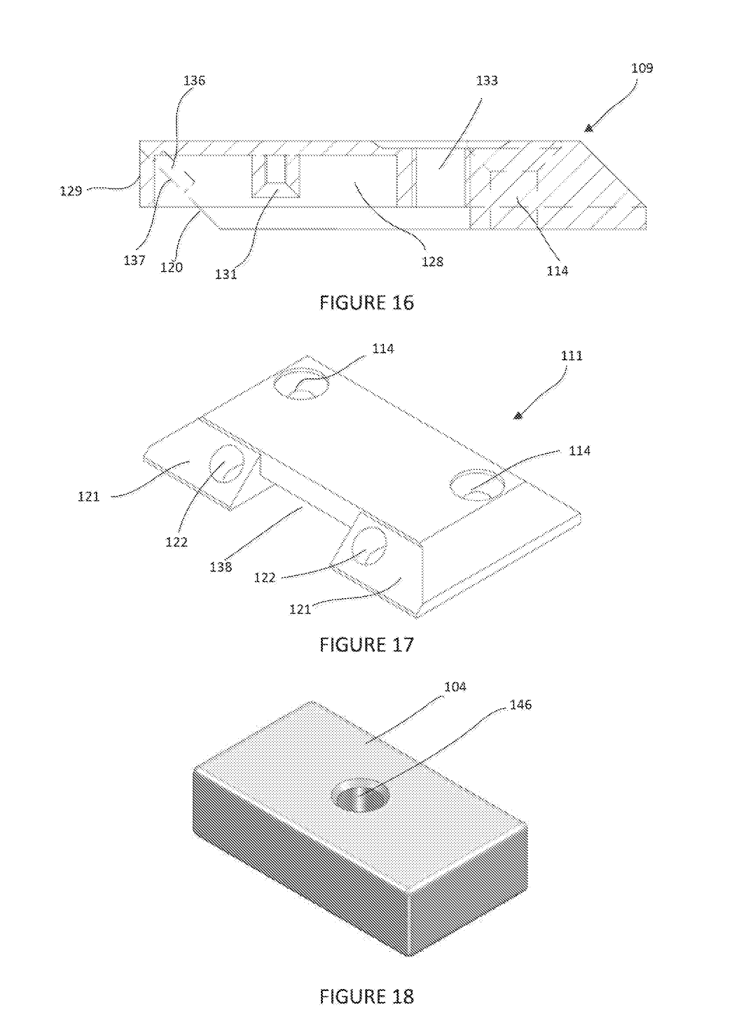

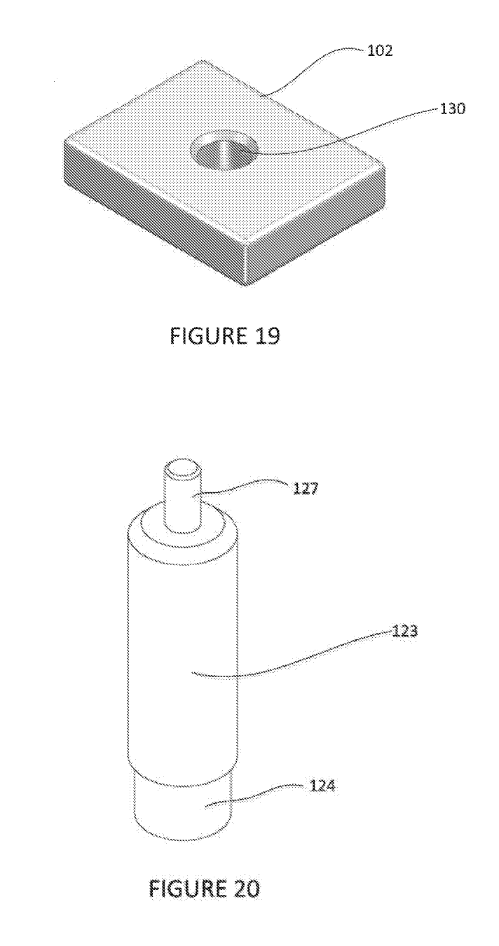

Referring to FIGS. 15 and 16, there is shown the first front plate 109 of the first hinge member 101 in isolation of the other components of the hinge 100. The first front plate 109 includes a cavity 128 on the underside defined by a wall structure 129 that tight fittingly receives the first magnetic element 102. As shown in FIG. 19, the first magnetic element 102 includes a central hole 130 that receives therethrough a threaded stem 131 located in the centre of the cavity 128. A screw 132 (see FIG. 6) can engage with the threaded stem 131 thereby securing the first magnetic element 102 to the underside of the first front plate 109.

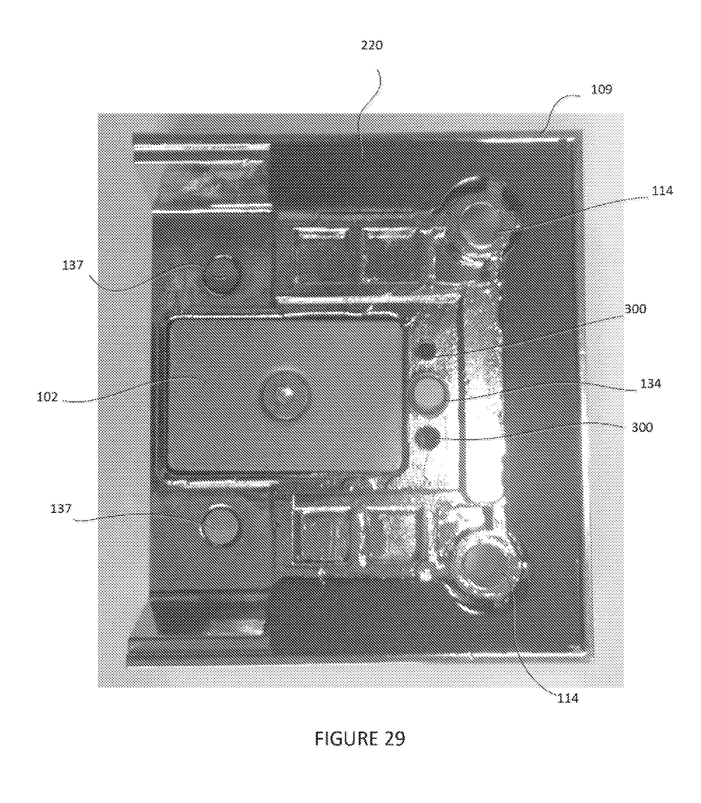

The first front plate 109 also includes a brake hole 133 for receiving therein a threaded element 134 such as a grub screw or the like which is part of the breaking mechanism 105. The threaded element 134 is a brake screw that can be adjusted to control the hinged movement of the hinge members 101, 103. A removable cover 135 is placed over the hole 133, wherein the perimeter of the cover 135 can be snap fittingly received within the permitter of the hole 133. Alternatively, the cover plate 135 can includes a pair of prongs which are snap-fittingly received within holes 300 (see FIG. 29) in the first front plate 109. The angled overlapping section 120 of the first front plate 109 includes one or more voids 136 for housing one or more striker plates 137 that the pins 127 strike when the hinge 100 approaches the retained position.

As can be seen from FIGS. 15 and 16, the first magnetic element 102 protrudes past a portion of the angled overlapping section 120 in order to assist with increasing the overlapping contact area of the magnetic elements 102, 104. Referring to FIG. 17, the underlapping angled section 121 has a central cut-away section 138 that enables the edge of the first magnetic element 102 to move adjacent the second magnetic element 104.

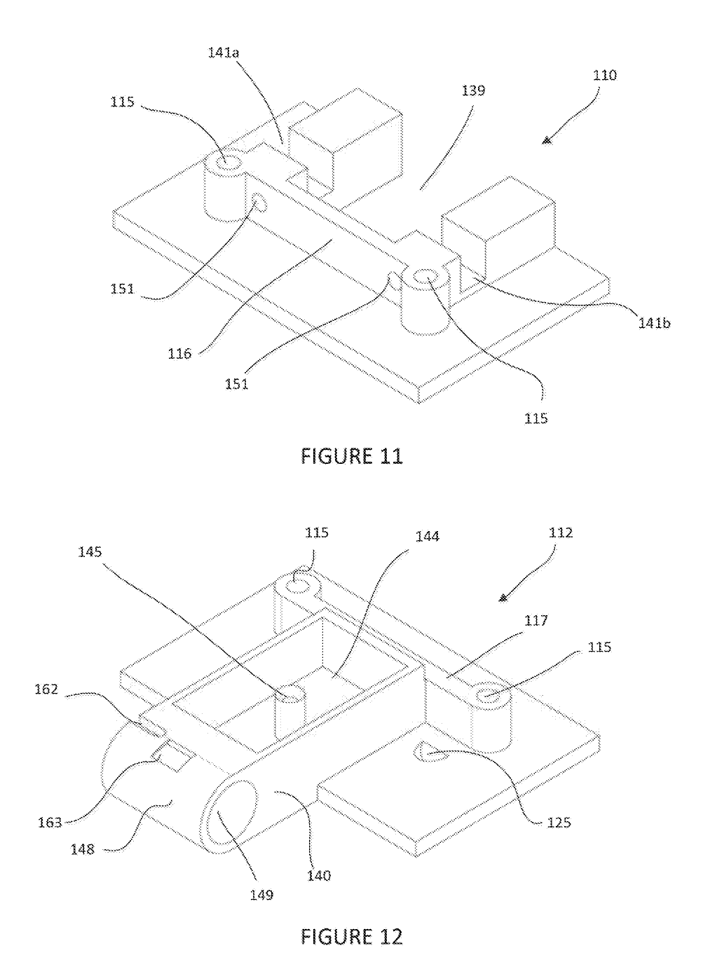

Referring to FIG. 11 there is shown the first rear plate 110 in isolation from the other components of the hinge 100. The first rear plate 110 includes a walled structure 116 that is upstanding from the planar inner surface 118 of the first rear plate 110. The first rear plate 110 has a C shape perimeter including a central cutaway section 138 defining a mouth 139 for accommodating a tongue 140 of the second rear plate 112. The walled structure 116 includes channels 141a, 141b for receiving end portions 142 of a hinge pin mechanism 143 as will be described in more detail below. The walled structure 116 includes threaded holes 115 for receiving screws 113 for coupling the first front plate 109 to the first rear plate 110.

Referring to FIG. 12 there is shown the second rear plate 112 in isolation of the other components of the hinge 100. The second rear plate 112 includes a walled structure 117, wherein the tongue 140 extends from the second rear plate 112. The tongue 140 is integral with the second rear plate 112. The tongue 140 has a cavity 144 located therein. The cavity 144 receives the second magnetic element 104. The cavity 144 includes a threaded stem 145 that is received through a central hole 146 of the second magnetic element 104. A screw 147 can be screwed into the threaded stem 145 thereby securing the second magnetic element 104 within the cavity 144 of the tongue 140.

The walled structure 117 of the second rear plate 112 includes threaded holes 115 for receiving screws 113 for securing the second front plate 111 to the second rear plate 112. As shown in FIGS. 12 and 14, the inner surface 119 of the second rear plate 112 includes a plurality of angled recesses 125 for receiving the end portions of the dampeners 123.

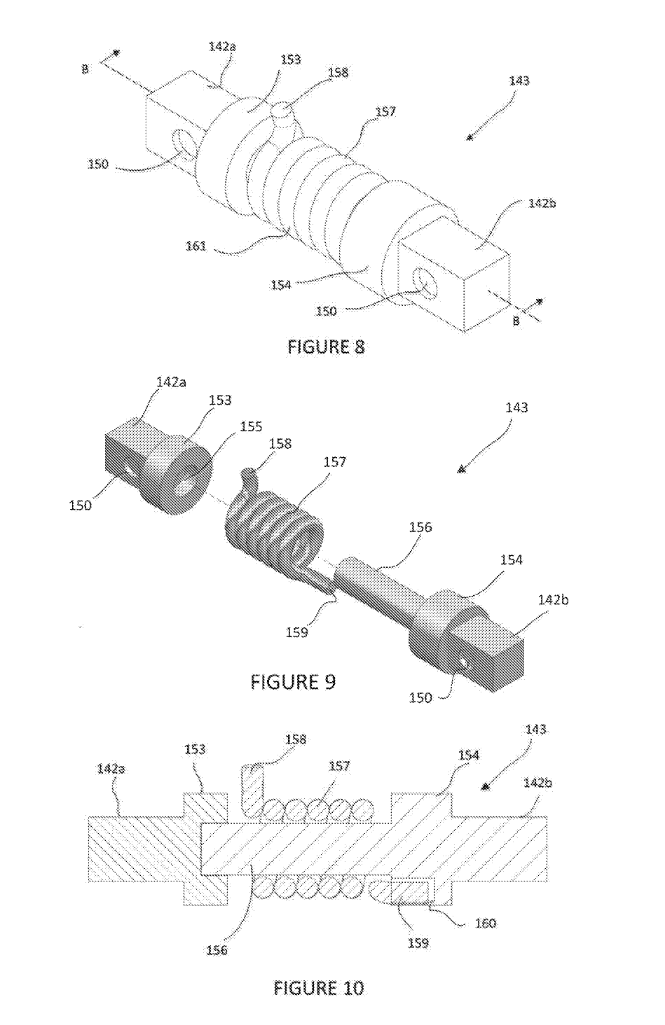

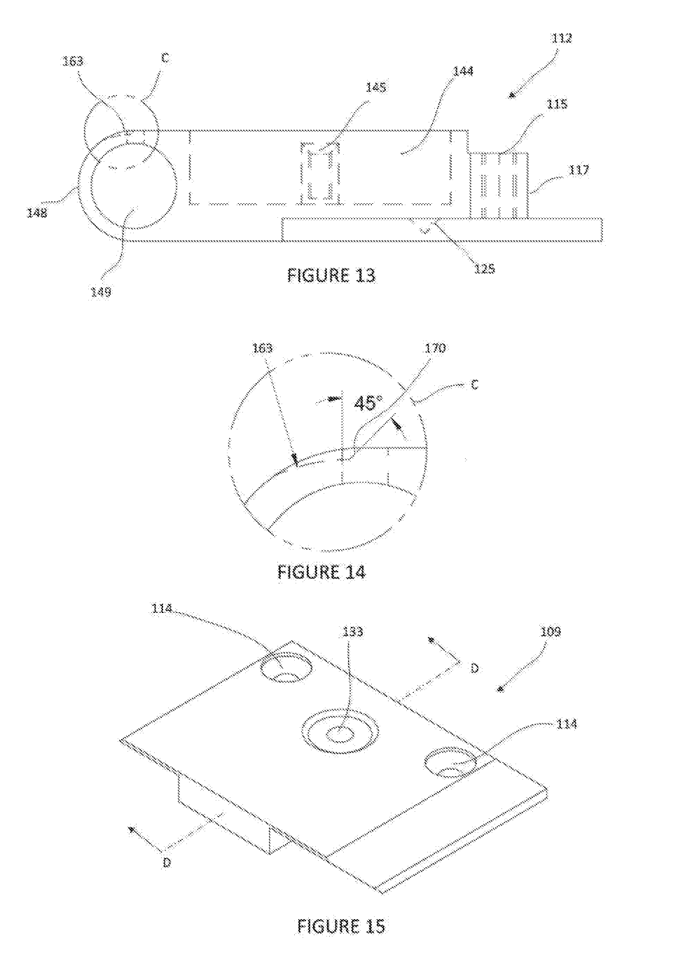

Referring to FIG. 13, the end 148 of the tongue 140 includes a substantially rounded end 148 forming a semi-cylinder. The end 148 of the tongue 140 includes a hollow 149 that substantially extends along the axis of the semi-cylindrical end 148. The hollow 149 has a cylindrical cross-section. The hinge pin mechanism 143, as shown in FIGS. 8 to 10, is received through the hollow 149, wherein a first end 142a and a second end 142b of the hinge pin mechanism 143 protrude from opposing ends of the hollow 149. The ends 142a, 142b of the hinge pin mechanism 143 sit within the channels 141a, 141b in the walled structure 116 of the first rear plate 110 to thereby pivotally couple the first hinge member 101 to the second hinge member 103.

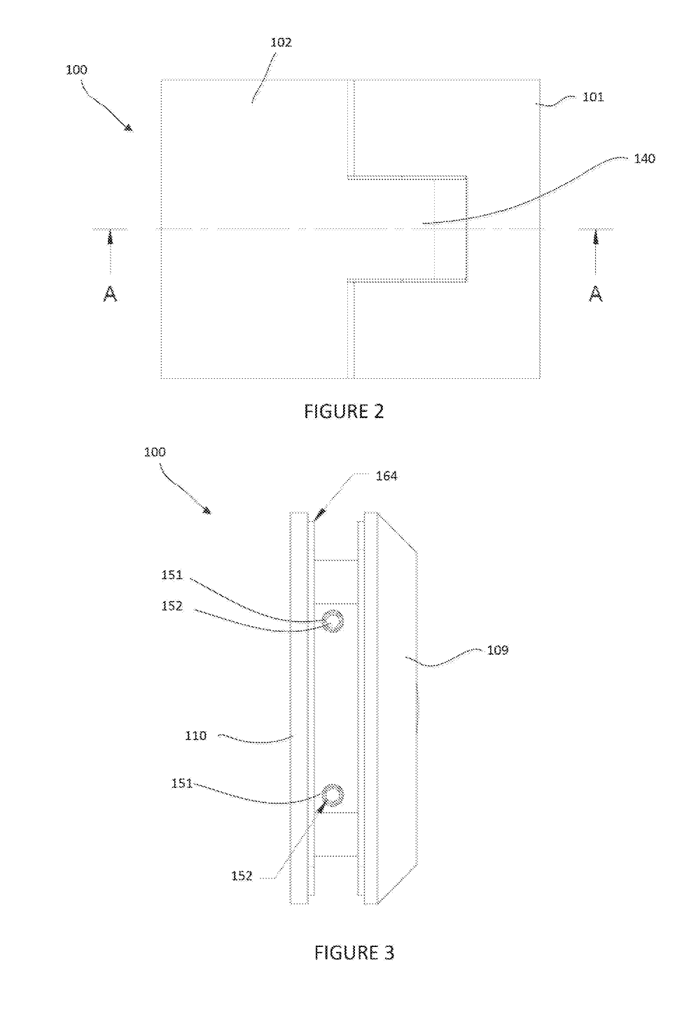

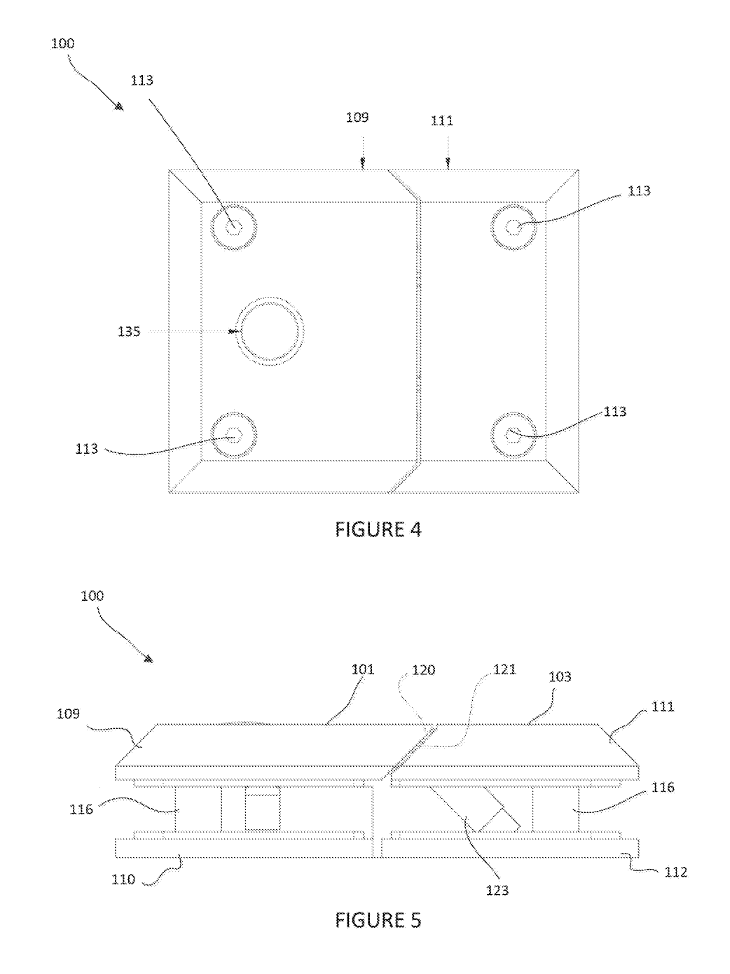

As shown in FIG. 8, side surfaces of the ends 142a, 142b of the hinge pin mechanism 143 include recesses 150 which align with holes 151 (see FIGS. 2 and 11) in the side surface of the wall structure 116f. Screws 152 can be screwed through the holes in the side surface of the wall structure 116 to project within the recesses 150 of the hinge pin mechanism 143 to thereby secure the hinge pin mechanism 143 to the walled structure 116 of the first rear plate 110.

As shown in FIG. 9, the hinge pin mechanism 143 includes a number of components. In particular, the hinge pin mechanism 143 includes the first end portion 142a including a first shoulder section 153. The first shoulder section 153 includes a void 155. The hinge pin mechanism 143 includes the second end portion 142b which includes a second shoulder section 154. A rod 156 extends from the centre of the base of the second shoulder section 154, wherein an end of the rod 156 is tight-fittingly received within the void 155 of the first shoulder section 153. A torsional spring 157 is placed over the rod 156 prior to the rod 156 being received within the void 155. A first spring tail 158 projects outwardly from the rod 156. A second spring tail 159 is tight fittingly received within a hole 160 in the base of the second shoulder section 154 as shown in FIG. 10. The spring 157 sits on the rod 156 between the shoulder sections 153, 154. The rod 156 acts as a spring stiffener to reduce deflection of the spring 157 whilst under tension.

As shown in FIGS. 8 to 10, the ends of the hinge pin mechanism 143 have a square profile which are received within correspondingly profiled channels 141a, 141b defined in the walled structure 116 of the first rear plate 110, thereby preventing rotation of the end portions 142a, 142b with respect to the channels 141a, 141b. As the second shoulder section 154 is operably connected to the first rear plate 110 via the channels 141a, 141b, the hinge pin mechanism 143 is operably connected to the first hinge member 101.

As shown in FIG. 22, the first spring tail 158 is located within a cut-out section 162, such as a slot, in the rounded section of the tongue 140, such that the spring 157 is also operably connected to the second hinge member 102. Due to the spring 157 being operably connected to both the first and second hinge members 101, 103, pivotal movement between the hinge members 101, 103 causes potential energy to build in the spring 157 causing the hinge members 101, 103 to be biased back to the retained position.

Referring to FIGS. 12 to 14, the rounded end of the tongue 157 includes a recessed section 163. As shown in FIG. 22, the recessed section 163 aligns with the braking screw 134 that protrudes through the central hole 133 of the first front plate 109. Referring to FIG. 23, the braking screw 134 frictionally contacts the outer surface of the rounded end of the tongue member 140 when in the open position thereby hindering hinged movement of the first hinge member 101 relative to the second hinge member 103. As the hinge 100 approaches the retained position, the braking screw 134 applies less, or no, frictional force to the rounded end of the tongue 140 due to the depth of the recessed section 163. The amount of frictional force applied to the tongue section 140 by the braking mechanism 105 can be adjusted by adjusting the depth that the screw 134 extends through the first front plate 109. The braking mechanism 105 should preferably be adjusted when the hinge 100 is located in the open position such that the end of the screw 134 contacts the outer rounded surface of the tongue 140 rather than the recessed section 163 which could potentially cause over-braking. Due to the recessed section 163 of the rounded end of the tongue 163 being provided in a limited area of the outer surface of the tongue 140, the braking mechanism 105 applies the braking force only to a range of the hinged motion between the first and second hinge members 101, 103.

As visible in FIG. 14, the recessed section includes a step 170 such that the brake screw 134 reapplies a braking force to the hinge should pivoting motion proceed further.

In a preferable embodiment, the braking screw 134 has a braking pad (not shown) located on the end of the stem, thereby minimising wear of the outer surface of the round end of the tongue 140.

As shown in FIG. 22, an insert 220 may be located on the inner surface of the front and rear plates 109, 110, 111 and 112 which rest against a contact surface of hinged structure 200.

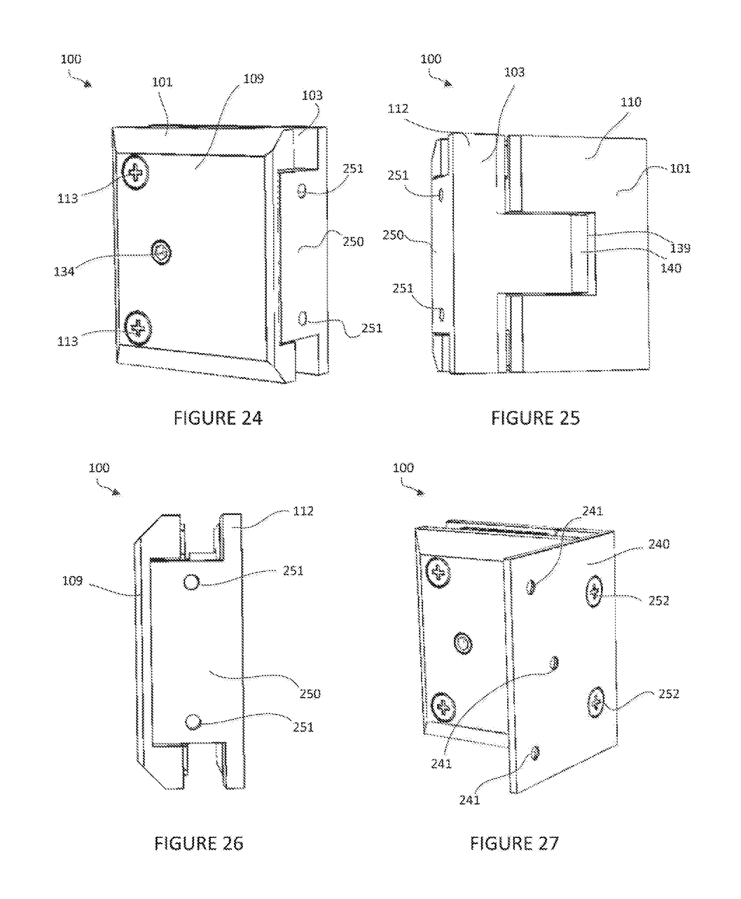

Referring to FIGS. 24 to 26, there is shown a further example of a hinge 100. In particular, the hinge 100 includes a first hinge member 101 pivotally connected to a second hinge member 103. The second hinge member 103 includes a mounting portion 240 provided in the form of a mounting block 250 for mounting the hinge 100 to a mounting surface, such as a wall or the like, such that the first hinge member 101 is mounted orthogonal to the mounting surface in the retained position.

As shown in FIG. 27, a mounting plate 240 may be coupled to the mounting block 250 of the second hinge member 103 such that the mounting plate 240 is then mounted to the mounting surface. The hinge plate 240 includes a plurality of holes 241 to enable fixing elements 252 such as screws or bolts to secure the hinge 100 to the mounting surface. As will be appreciated, the second hinge member 103 in this embodiment is not designed to retain a structure, such as a glass door, between hinge plates as discussed in earlier embodiments.

The first hinge member 101 is designed in the same manner as that of earlier embodiments and thus will not be repeated for clarity purposes. However, as is notable in FIGS. 24 and 25, the front plate 109 substantially extends the length of the hinge 100. The rear plates 110, 112 have a length that is substantially equal to the length of the front plate 109 of the first hinge member 101. As shown in FIG. 25, the second hinge member includes the protruding tongue 140 which is received within the gap 139 of the rear plate 110.

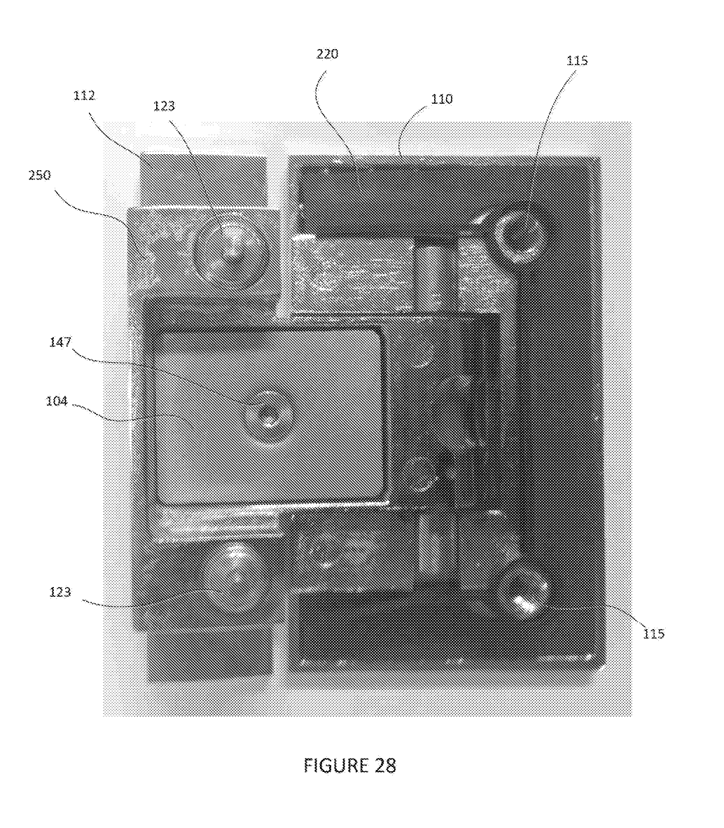

Referring to FIG. 28 there is shown the inner surfaces of the rear hinge plates 110, 112. As can be seen in relation to the rear hinge plate 110, the arrangement of this hinge plate 110 is the same as earlier embodiments and thus will not be repeated for clarity purposes. However, the mounting block 250 of the rear hinge plate 112 includes screw-threaded voids that receive therein the dampeners 123 for slowing the movement of the hinge 100 to the retained position. The dampeners 123 are orientated substantially orthogonal to the axis of the mounting holes 251 of the mounting block 250. As can be seen in FIG. 28, the cylindrical section of the tongue 140 of the second hinge member 103 includes the recessed section to enable an adjustable braking function.

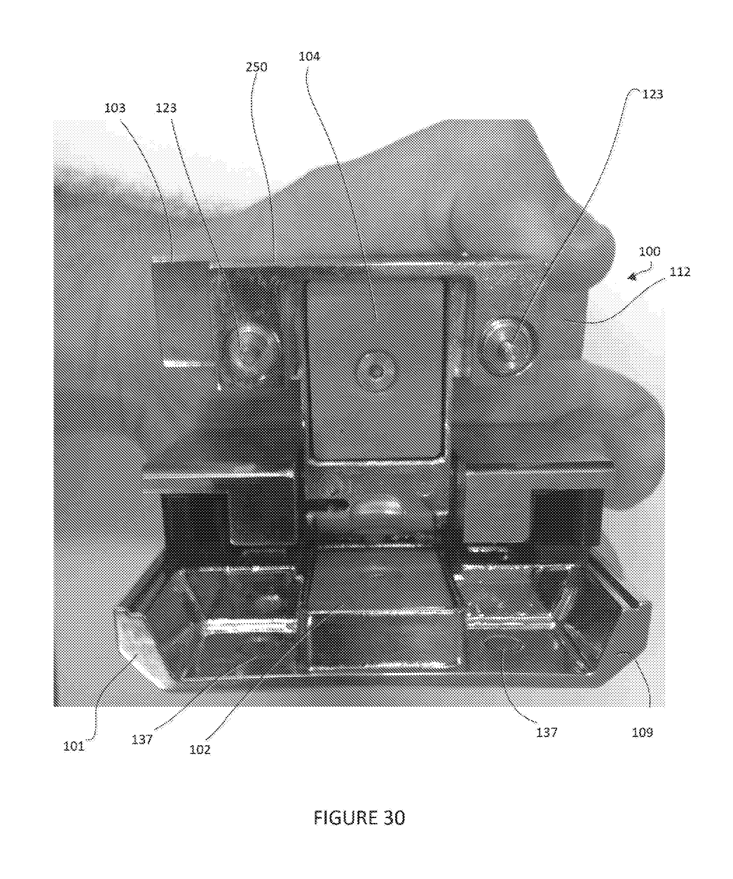

Referring to FIG. 29 there is shown the inner surface of the front hinge plate 109. FIG. 29 is substantially similar in design to that of the front hinge plate 109 shown in FIGS. 15 and 16. However, as seen in FIG. 29, the striker plates 137 are orientated substantially parallel with the plane of the front hinge plate 109 due to the orientation of the dampeners 123. It will be appreciated that in alternate embodiments, the dampeners 123 of this embodiment of the hinge 100 can be angled as shown in previous embodiments to reduce the packaging of the hinge 100. FIG. 30 shows the hinge 100 in the open position, wherein rear plate 112 is pivotally moved relative to hinge plates 109, 110.

It will be appreciated that the hinge 100 may be provided in the form of a kit of parts, wherein the parts are assembled and installed to secure the hinge to the hinged item. The kit of parts may additionally include one or more tools such as Allen keys to screw items together to assemble the hinge 100.

Optional embodiments of the present invention may also be said to broadly consist in the parts, elements and features referred to or indicated herein, individually or collectively, in any or all combinations of two or more of the parts, elements or features, and wherein specific integers are mentioned herein which have known equivalents in the art to which the invention relates, such known equivalents are deemed to be incorporated herein as if individually set forth.

Although a preferred embodiment has been described in detail, it should be understood that various changes, substitutions, and alterations can be made by one of ordinary skill in the art without departing from the scope of the present invention.

1: A hinge including:
a first hinge member including a first magnetic element;
a second hinge member including a second magnetic element, wherein the first and second hinge members are pivotally mounted together;
a braking mechanism configured to hinder movement of the first hinge member relative to the second hinge member during at least a portion of hinged motion; and
a biasing mechanism configured to bias the first hinge member and the second hinge member toward the retained position;
wherein the first and second hinge members are substantially maintained in a retained position via magnetic force between the first and second magnetic elements.

2: The hinge according to claim 1, wherein a braking force created by the braking mechanism is adjustable.

3: The hinge according to claim 2, wherein the braking mechanism includes a threaded element mounted in the first hinge member, the threaded element being in contact with the second hinge member and hindering relative motion by friction.

4: The hinge according to claim 2, wherein the first hinge member includes a removable cover for covering the threaded element.

5: The hinge according to claim 2, wherein the second hinge member includes a recessed section such that the braking force applied by the braking mechanism varies through the hinged motion.

6: The hinge according to claim 5, wherein the second hinge member includes a tongue which is pivotally secured to the first hinge member, wherein a surface of the tongue includes the recessed section.

7: The hinge according to claim 6, wherein the tongue includes a rounded end section, wherein the recessed section is provided in the rounded end section of the tongue.

8: The hinge according to claim 6, wherein the rounded end of the tongue includes a hollow, wherein the tongue is pivotally secured to the first hinge member via a hinge pin mechanism which is at least partially housed within the hollow and is secured to the first hinge member.

9: The hinge according to claim 8, wherein the hinge pin mechanism includes:
a first end portion including a first shoulder section having a void;
a second end portion including a second shoulder section having extending therefrom a rod; and
a spring which is coaxially located upon the rod, wherein a portion of the rod is secured within the void thereby securing the spring to the first and second end portions.

10: The hinge according to claim 9, wherein a first spring tail of the spring extends outwardly from the rod and a second spring tail is secured to the second shoulder section.

11: The hinge according to claim 10, wherein the tongue includes a cut-out section which receives therein the first spring tail.

12: The hinge according to claim 1, wherein the first hinge member includes an angled overlapping portion which urges against a portion of an angled dampening mechanism protruding from second hinge member, wherein the dampening mechanism has an axis which is substantially orthogonal to the angled overlapping portion, wherein the dampening mechanism is configured to slow the hinged movement of the first hinge member relative to the second hinge member.

13: The hinge according to claim 12, wherein the overlapping portion of the first hinge member is a chamfer and the second hinge member includes an underlapping portion providing a complementary chamfer, wherein the overlapping portion rests against the underlapping portion when the hinge is in the retained position.

14: The hinge according to claim 13, wherein a face of the overlapping portion includes a striker plate which strikes a pin protruding from the dampening mechanism as the hinge approaches the retained position.

15: The hinge according to claim 13, wherein the underlapping section includes a plurality of angled apertures for enabling a body of the dampening mechanism to protrude through a front hinge plate of the second hinge member.

16: The hinge according to claim 15, wherein an end portion of the dampening mechanism rests in an angled recess in a rear hinge plate of the second hinge member.

17: The hinge according to claim 1, wherein the hinge includes a plurality of dampening mechanisms to slow the hinged movement of the hinge toward the retained position.

18-19. (canceled)

20: The hinge according to claim 1, wherein the first hinge member includes a first front plate and a first rear plate which secure a hinged item therebetween, and the second hinge member includes a second rear plate, wherein the first front plates extends a length of the hinge.

21: A hinge including:
a first hinge member including:
a first magnetic element; and
an angled overlapping portion;
a second hinge member, pivotally mounted to the first hinge member, including:
a second magnetic element, wherein the first and second hinge members are substantially maintained in a retained position via magnetic force between the first and second magnetic elements; and
a dampening mechanism configured to slow the movement of the first hinge member relative to the second hinge member, wherein the dampening mechanism is orientated substantially orthogonal to the angled overlapping portion which urges against the dampener when approaching the retained position; and
a biasing mechanism configured to bias the first hinge member and the second hinge member toward the retained position.

22-40. (canceled)

41: A kit of parts for a hinge including:
a first hinge member including a first magnetic element;
a second hinge member including a second magnetic element, wherein the first and second hinge members are to be pivotally mounted together;
a braking mechanism configured to hinder movement of the first hinge member relative to the second hinge member during at least a portion of hinged motion; and
a biasing mechanism configured to bias the first hinge member and the second hinge member toward the retained position;
wherein the first and second hinge members are substantially maintained in a retained position via magnetic force between the first and second magnetic elements.

42. (canceled)
